(19) United States
(12) Patent Application Publication
(10) Pub. No.: US 2016/0217439 A1
(43) Pub. Date: Jul. 28, 2016

(54) INTEGRATED PAYMENT SYSTEM AND COLLECTION REPORTING METHOD

(71) Applicant: Kelly G. Martin, Woodstock, GA (US)

(72) Inventor: Kelly G. Martin, Woodstock, GA (US)

(21) Appl. No.: 14/705,070

(22) Filed: May 6, 2015

Related U.S. Application Data
(63) Continuation-in-part of application No. 14/627,403, filed on Feb. 20, 2015.
Application No. 14/627,403 is a continuation-in-part of application No. 14/604,300, filed on Jan. 23, 2015.

(51) Int. Cl. G06Q 20/10; G06Q 20/22

(52) U.S. Cl. CPC G06Q 20/102; G06Q 20/227

(57) ABSTRACT

An integrated system for electronic payment to one or more departments or agencies within a city, township, county, local or state government. The system has a plurality of separate agency or department databases and an icon or module menu of each department at a payment kiosk or payment computer connected to each database. Activating the icon or selecting the module directs a payor to the desired agency or department database. Inputting the payor information into the kiosk or payment computer retrieves an invoice or bill to be paid. An integrated system provides the payor requested invoice, bill, fee, tax or fine for that department or agency and simultaneously checks the payor information against each other database for any outstanding bills, fees, taxes or fines and generates a list of said outstanding bills, fees, taxes or fines, and upon payment automatically updates the databases to reflect the received payment.

### RELATED APPLICATIONS

This application is a continuation in part of U.S. application Ser. No. 14/627,403 filed on Feb. 20, 2015 entitled “Integrated Payment System And Collection Reporting Method” which is a continuation in part of U.S. application Ser. No. 14/604,300 filed on Jan. 23, 2015 entitled “Automated Payment Collection System And Method”; the contents of each are incorporated herein by reference in its entirety.

### TECHNICAL FIELD

The present invention relates to a system and associated method of coordinating a systematic payment system for municipalities, counties, state and or federal governments wherein a user activated payment initiates and creates an automatic check of outstanding invoices, fines and fees owed to other departments within the municipality, county, state or federal government or a manual input by staff initiates the check off and wherein payments of related and unrelated matters are automatically reported back to the original initiating agencies or departments.

### BACKGROUND OF THE INVENTION

The current operation of local, city, county or state agencies is one of a large collection of departments and offices that provide various governmental services to the public. Each of these departments can and does charge fees, collect taxes or create invoices, fines and fees for users for the services provided. Each department or agency provides its own collection and processing of payments or contracts this to outside vendors.

The funding of the activities within these governmental entities relies heavily on the tax revenues generated and collected and the payments of fees, fines and invoices payable to the various agencies. Accordingly, the budgeting and funding relies on an efficient collection system.

Unfortunately, the fact that these municipal enterprises are so diverse and disparate and compartmentalized and the range of activities so broad, there is no effective way to coordinate all the various activities in such a way that one agency understands or has access to the others databases and as a practical matter, some agencies are so specialized that standardizing the computer database may in fact degrade some agencies compatibilities.

Typically, the training and systems in place at one agency may not be comparable to another, nevertheless, many software firms attempting to modernize interdepartmental interfaces by requesting or worse requiring scrapping entire systems in an individual agency to allow adoption of more generic programming that actually is more cumbersome and less customizable for a particular department or agency.

The fact is the “sunk cost” already in these custom fitted systems within a department can be in the millions of dollars. Scrapping them only increases the front end cost of modernizing. This may prevent any improvement progress. What is needed is a way to coordinate collections without interfering with the existing systems.

The present invention provides a payments collection solution without changing or degrading the agencies or departments current systems. This allows an implementation with no cost for replacing existing programs and methods as is currently required by others in this field. The present invention provides a cross check of all connected agencies and departments providing optional debt retrieval from each agency at the time of a single user transaction or staff input. This creates an efficient way to pay related and unrelated transactions as is described in co-pending application U.S. Ser. No. 14/604,300. This, however, is an essential, but only initial step. The present invention further defines how that initial payment transaction can be automatically and virtually simultaneously be accounted for not only at the source of payment, but also at the invoice generating agencies or departments. The fact that a payor may be paying for multiple transactions means a system to acknowledge this is needed. The following invention described hereinafter meets this objective.

### Definitions

“Payment Compass” means a computer application or software that handles payments in the Government Window® system.

“Tri-Angulation” refers to the portion of the software in the Government Window® system that searches the various agencies or departments.

### SUMMARY OF THE INVENTION

A method of using a payment compass has the following steps: the user initiates a payment application using a payment kiosk or computer connected to an integrated system, wherein the payment application draws the data from an agency or department database showing the user his balances and requesting if he wants to pay them, and the system searches other agencies or departments and finding other agencies departments with outstanding balances for this user; showing any other outstanding balances for each other agency or department and prompting by asking the user if he wants to pay one or more of these balances as now; and wherein all the selected payments the user chooses to pay are added to a payment basket within the payment compass and the user is asked to input a payment method, whatever he chooses, the payment compass itemizes the bill for the user but deducts only one payment for all outstanding items with this city or county, deducts another payment for the processing fee and the proceeds to deposit the respective balances into the accounts of each of the agencies the user chose to pay, while at the same time updating the payment records for each agency paid.

A system for electronic payment to one or more departments or agencies within a city, township, county, local or state government. The system has a plurality of separate agency or department databases and an icon or module menu of each department at a payment kiosk or payment computer connected to each database. Activating the icon or selecting the module directs a payor to the desired agency or department data. Inputting the payor information into the kiosk or payment computer retrieves any invoice to be paid to that agency/department. An integrated system provides the payor requested invoice of a bill, fee, tax or fine for that department or agency and systematically checks the payor information against each other agency/department database for any outstanding bills, fees, taxes or fines and generates a list of said outstanding bills, fees, taxes or fines.

The payor can select to pay any singular, selective multiple, or all of the outstanding bills. Similarly, the agency can collect only the invoice generated or can collect one or more of said outstanding bills.

Optionally, should the payor refuse to pay any outstanding bill, depending on the discretion of the agency/department, the outstanding bills can be sent as liens against state income tax refunds per House Bill 1000 for immediate collection. At the time of payment, the transaction generates a payment confirmation receipt and sends a payment transaction notification to the agencies/departments paid to reflect the payment and eliminate the debt.

A method for a payor to make an electronic payment to one or more departments or agencies within a city, township, county or local or state government has the steps of coming to a physical local government agency or department; logging on to their payment site, computer or kiosk; selecting the department or agency where the desired transaction is to be made; entering the information needed to retrieve the desired transaction to be paid; providing the payor's desired method of payment including payor information identifying the payor; thereafter searching other department or agency databases within said local government and cross checking each connected database for outstanding invoices, bills, fines, fees payments or taxes; generating a list of payor debts owed; and offering the payor the option of paying said debts.

The invention is parameter driven, allowing agencies/departments to control:

i) which agencies/departments will participate in the cross departmental collection process (Tri-Angulation™)

ii) Whether part-payments are allowed and,
a. If so allowed; which departments accept part payments and which don't, further defined by percentages where applicable,
b. If not allowed, the rules governing which agencies/departments must be paid, collectively, or singularly.

iii) The method of payment further may include the step of placing a lien on withheld income taxes as a source of invoice payment for the collective outstanding items to the agencies/departments or selective singular agencies/departments as defined by those agencies/departments. The lien process will be further controlled by rules defined by the participating agencies/departments.

### BRIEF DESCRIPTION OF THE DRAWINGS

The invention will be described by way of example and with reference to the accompanying drawings in which:

FIG. 1 is a diagrammatic view of a user payment interface of the present invention.

FIG. 2 is a similar view to FIG. 1 showing the user payment interface.

FIG. 3 is a schematic flow chart of the method of using the present invention within a regular payment process.

FIG. 4 is a detailed view of the multi-agency/department transaction search and retrieval system. (the Tri-Angulation™ process.)

FIG. 5 is a data summary screen for the system administration of the present invention.

FIG. 6 is the same screen as in FIG. 5, but on a smart phone.

FIG. 7 is a diagrammatic view of how the payment compass functions when a payor/user initiates and completes a payment.

FIG. 8 shows a data screen of an alternative use of Government Window Payment Compass.

### DETAILED DESCRIPTION OF THE INVENTION

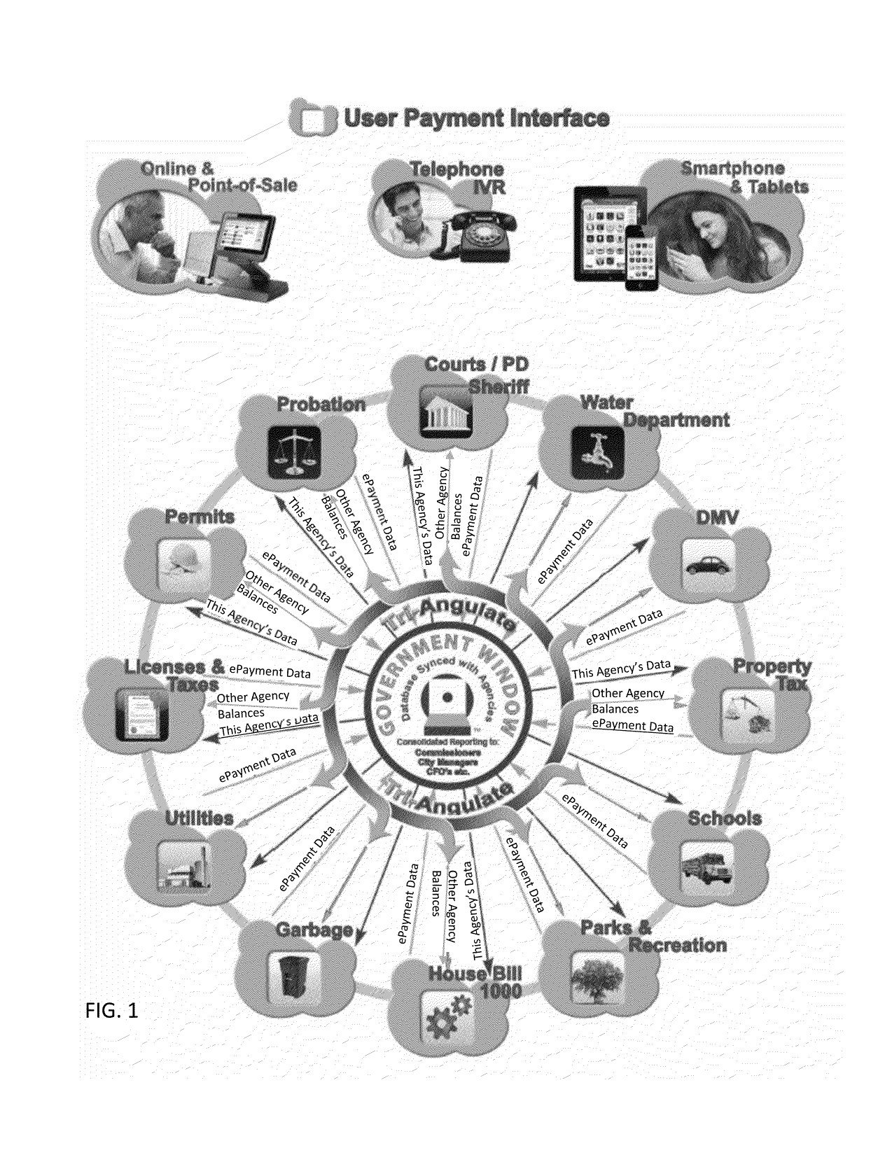

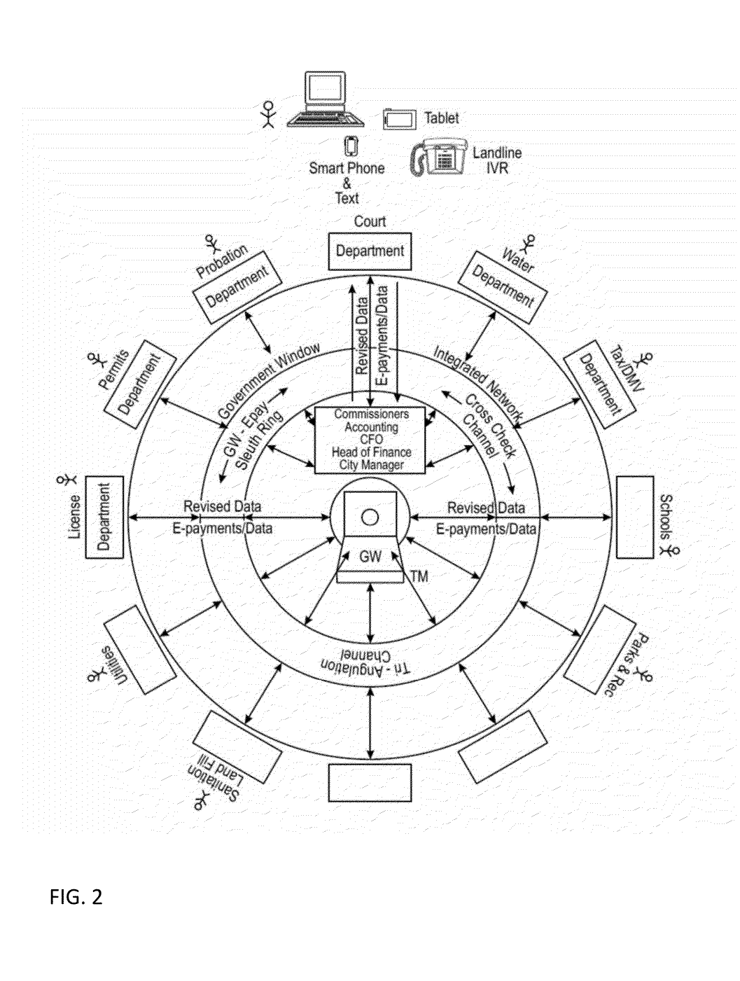

With reference to FIGS. 1 and 2, a schematic diagram is shown showing the user payment interface. As shown, the top icons show an online point of sale capability or an optional telephone interactive voice response (IVR) payment capability or an add-on application that can be provided on a smart phone or tablet allowing the user to make payments as needed. These capabilities can be provided for electronic payment of any debt to a local government agency, local municipalities such as cities, townships or counties have numerous agencies which generate bills or invoices such as fines, taxes, penalties, child support or the like. These must be paid by the citizen charged with such payments. An important aspect of the present invention is that it provides each agency a unique way of making a collection from a user in such a fashion that not only will its bill be paid, but it alerts the user and the agency of other outstanding bills in the related agencies in the jurisdiction whether it be a county, city, state or township. The invention takes separate databases that can be totally independent otherwise and have them connected on an electronic payment system that provides an interactive system that upon the initiation of user input such as identifying indications such as name, address, social security number or driver license will provide sufficient information for the system to cross check that information against every database connected to the system.

As shown in FIG. 1, the individual departments are illustrated around the outer perimeter. These can include the probation department, the courts, the police or sheriff department, the water department, department of motor vehicles (DMV), property tax, schools, parks and recreation, garbage, utilities, license and taxes, and permits. These different agencies are unique and distinct and have their own computer software generally. An important aspect of the present invention is that these systems need not be altered in any fashion. A simple edition shown in a center ring is a connecting area shown best in FIG. 2 as a cross check channel. It is an integrated network. This integrated network often called Government Window® by the inventors provides a means for connecting each department that is independently and otherwise very diverse in either their software programming or their systems to be connected for bill collection and payment. This center ring, if you will, creates a sleuth ring identified as a sleuth because it enables the user input to quietly and conveniently be cross checked at the various departments. For example, a person expecting a building permit goes to the building permit department and finds that he would have an invoice for permit of approximately $200.00; however, as the system is inputted with the payor information, it notes that this person also has additional 10 or 20 invoices for unpaid parking fines. At this point the agency can make a determination whether to allow the person to get the permit or whether or not they also want to collect on the outstanding parking fines. At this point an agency can, at its discretion, can either collect the fee that it otherwise would have or preferably collect all the fees that are due to the government agency. These fees may seem minor, however, when thousands of citizens have unpaid bills that are due and collectible, it can add up to be in the millions of dollars. This makes a difference in whether property taxes need to be raised or department funding has to be cut. By getting proper collections in, these outstanding bills can be quickly and promptly processed using this system.

Additionally, a new bill passed recently called House Bill 1000 (HB 1000) permits liens to be placed on any outstanding county or state or local government bill. Such a lien would be applied against a person's income taxes being withheld. When this lien is placed, the payments can be made directly to the agency. This helps insure that state tax refunds aren't paid to citizens who have outstanding municipal, city, county or state bills. This creates a vast advantage over prior systems that in the past, in order to accomplish this, all of the software in each department must be able to communicate with the others. This created an undue burden that made it impossible for agencies to work together in a systematic way to achieve a sufficient collection retrieval system. The present invention provides a way of doing this.

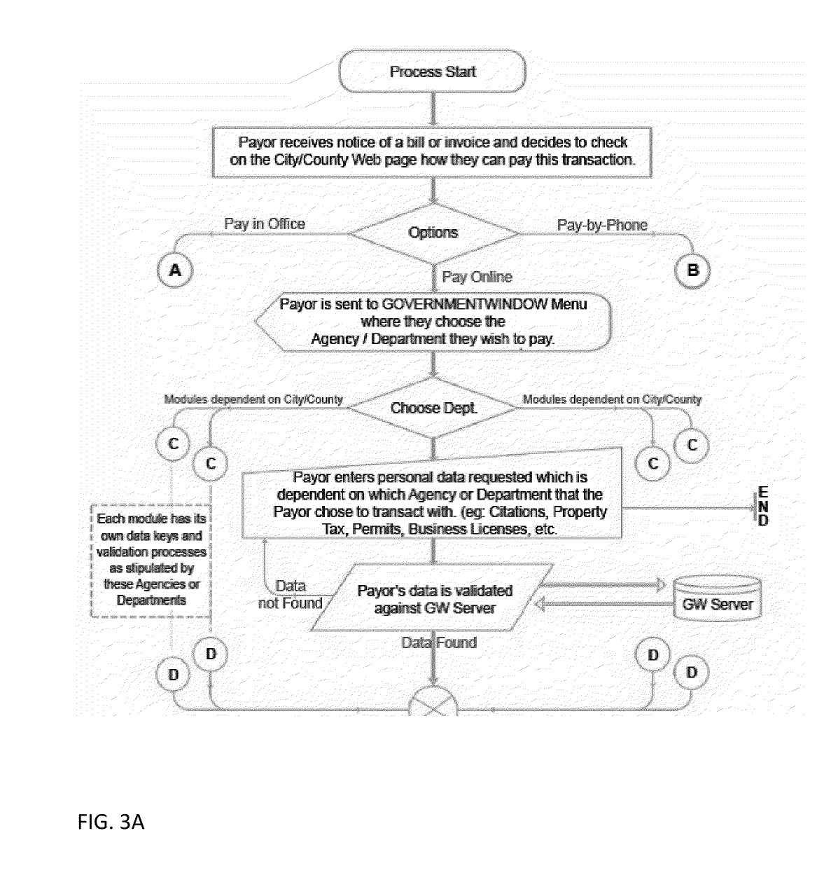

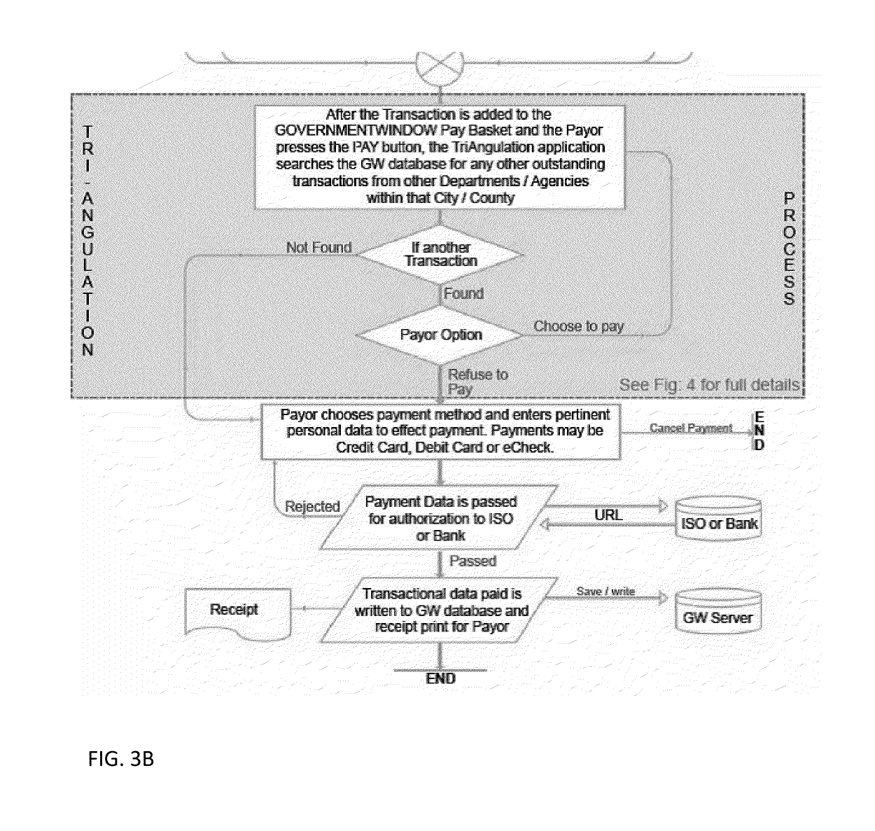

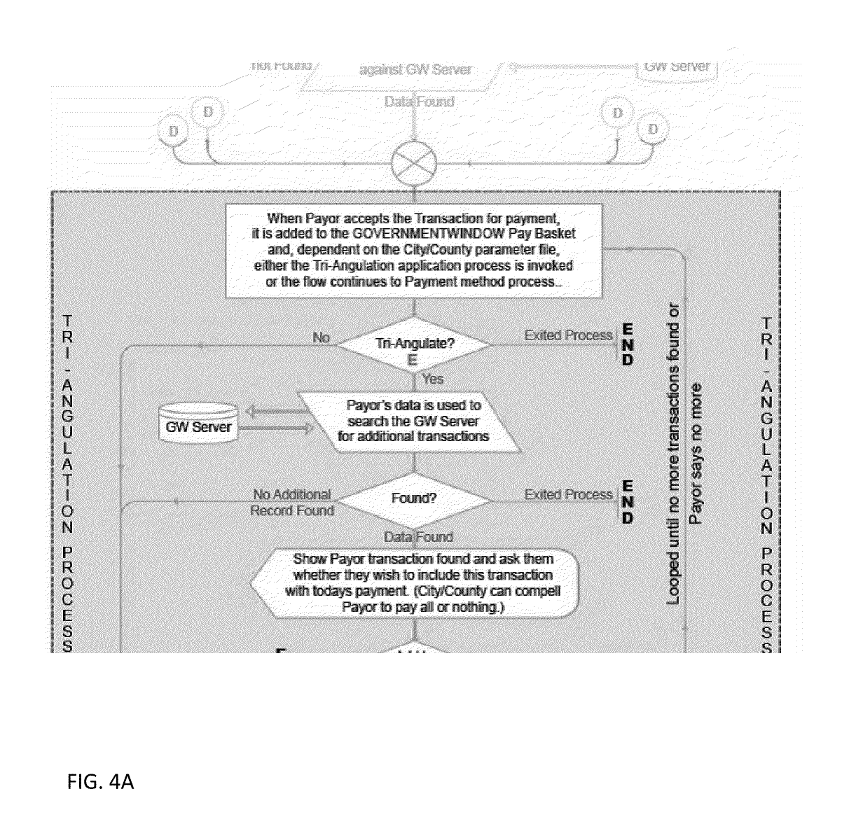

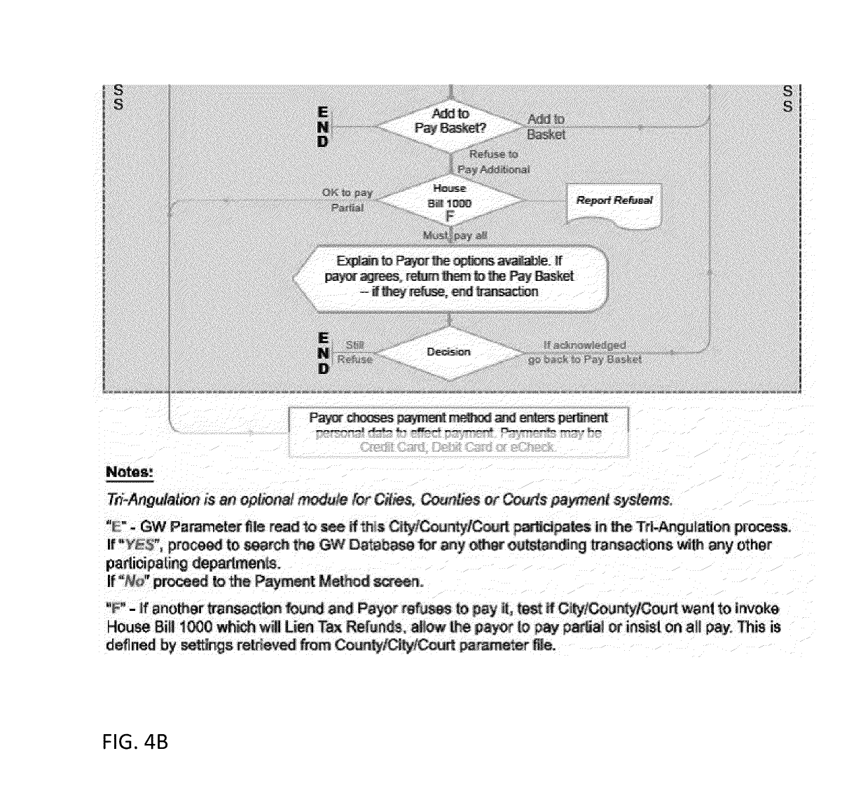

As shown in FIG. 3, a payor will come to a local government site or directly to Government Window® payment kiosk, which could be on a tablet or a phone, and decide which department they want to do business with by selecting an icon or module on a menu. They click on a picture of a government department and the payor enters any necessary data for the local needs, rules or laws per icon module. The integrated system will then check the network database and identify file or information the citizen has requested. If found, this outstanding transaction will be retrieved and displayed to the payor requesting the payor's confirmation that this is indeed the item they wish to pay. Once verified, the invention will search other participating agencies/departments connected in the inner ring called the sleuth ring and triangulates this information in such a fashion that any outstanding bills will be triggered and a list of these bills will be identified and the payor will be notified of the awareness of the agency or department of all these outstanding bills. The sleuth check ring is an ideal way of giving information to the payor of any outstanding bills they may need to pay. The payor may be given the option to pay each, selective or all of these outstanding items, dependent on the parameters set by the participating agencies/departments. If the payor opts not to pay all the bills, (at the discretion of the agency/department,) the invention will process only the requested transaction. If the agency/department has chosen not to allow the payor to make singular or part payments, the payor will not be allowed to pay the necessary transaction that he asked for, or alternatively, he will have to pay one or more of the outstanding bills. If the payor refuses to pay any of the outstanding items, the state has the option of providing a lien against future income tax refunds for all these payments within that state or jurisdiction. The lien portion is also governed by a set of parameter rules defined by the participating agencies/departments. By way of example: The payor has chosen to pay for a construction permit of $500 and has logged into the City Engineer's Department to make this payment. The invention retrieves the sought record but also retrieves an outstanding property tax bill or $400 which is now four months overdue. The city has defined in their parameters that any property bill that is outstanding longer than 3 month must be paid before any new permits will be issued but also defined that if the payor refuses to pay it after notification, (such as; on this payment portal,) a tax lien should be invoked. Thus the invention adds this transaction to the payor's payment basket and adds the amount to the bill. The payor may now pay this entire bill of $900 ($500 permit plus $400 tax bill) or, pay only the tax bill of $400, or refuse to pay any of the amounts. Should the payor refuse to pay any, the invention will advise the payor that by not paying the tax bill, the city reserves the right to raise the lien on any future tax refunds. The payor can then accept that lien or be returned to the payment screen to pay the tax. Exiting the system without any payment will flag the tax bill for the city to take further action, if desired.

When the payor completes his payment of an invoice, he will receive a confirmation that his credit card or debit card has been accepted. As part of his identifying information, the payor preferably provides his email address and will receive an email confirmation that this invoice has been paid. This receipt will reflect all the payments made. In the event multiple payments to different agencies or departments are included in the transaction; the receipt will reflect each agency or department's debt payment and for what it is being applied to. The system that provides this connective virtual ring to triangulate the debt data on the identified payor and has accessed all the connected agencies and departments to generate the payment transaction list is still connected to these agencies. So when the payment is accepted, a report that payment of a specific fine, fee, bill or tax has been received is sent as part of the transaction to the specific database of the agency or department. This occurs within fractions of a second and insures the payor is protected from any further collection actions or even bench warrants. This feedback heretofore did not exist and payments had to be manually loaded.

The system automatically reconciles a payment to a debt by use of the cross-departmental or agency connection to the system. The payor who may have never visited the various places he owed, can clear all debt obligations in a single transaction. Similarly, the payor who would have mailed in a check or money order and waited for a receipt can avoid all of that while the receiving agency or department avoids any manual transaction costs associated with entering the payment and canceling the debt.

Returned checks for insufficient funds are avoided and the costs associated with that are eliminated.

The system efficiently has the payor or the staff person loading the payor information accomplishing all the work needed for the system to provide the reconciliation of the data eliminating vast amounts of staff accounting time. This data is created at the point of payment. As used herein, the term payor is defined to mean the citizen or person to whom a bill, fine, fee, tax or ticket has been assigned or named. It does not mean necessarily the person to whom a credit card is issued to. A parent or spouse or relative may of course pay another's bill for example, but the record will reflect the named party in the transaction as the payor regardless of the source of the funds when a third party pays the actual bill for the “payor”.

This payment reconciliation and data reporting is part of the overall system shown in FIGS. 1 through 3 of collection and payment and is extremely valuable component. The electronic payment transaction can occur at a department or agency, by using an online point of sale computer, a smart phone or tablet connected by an app or by telephone IVR. The payor identifying information he or she provided will inform the user of all outstanding payments.

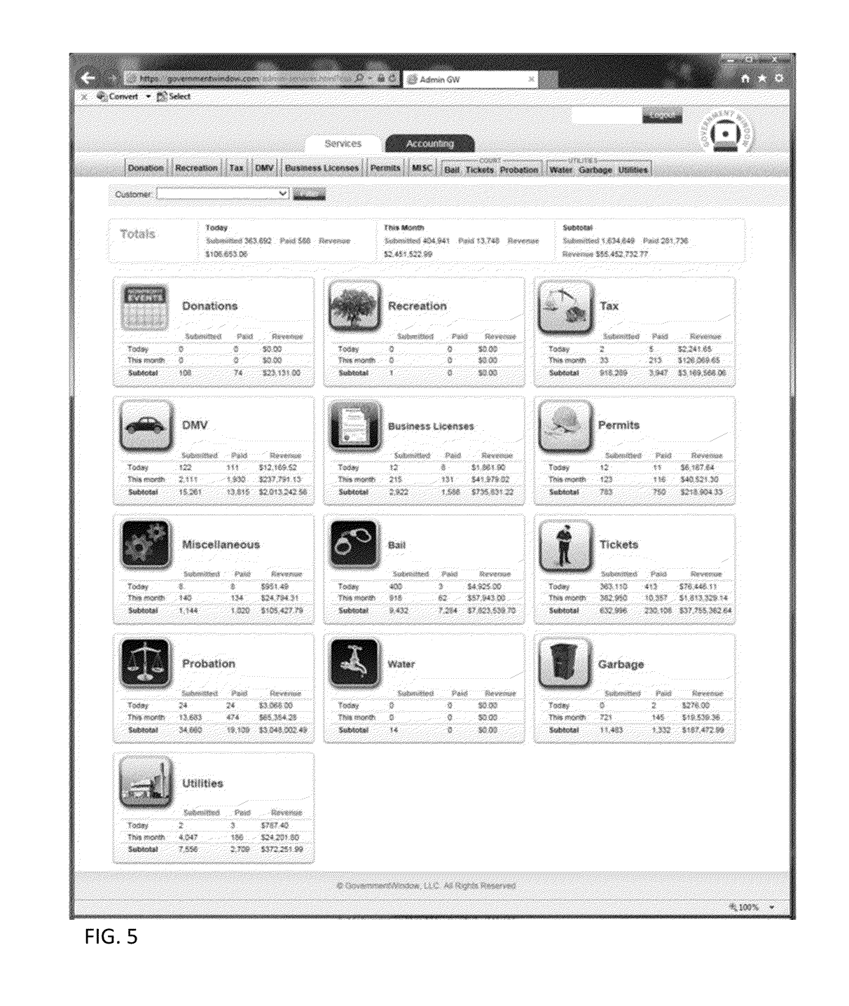

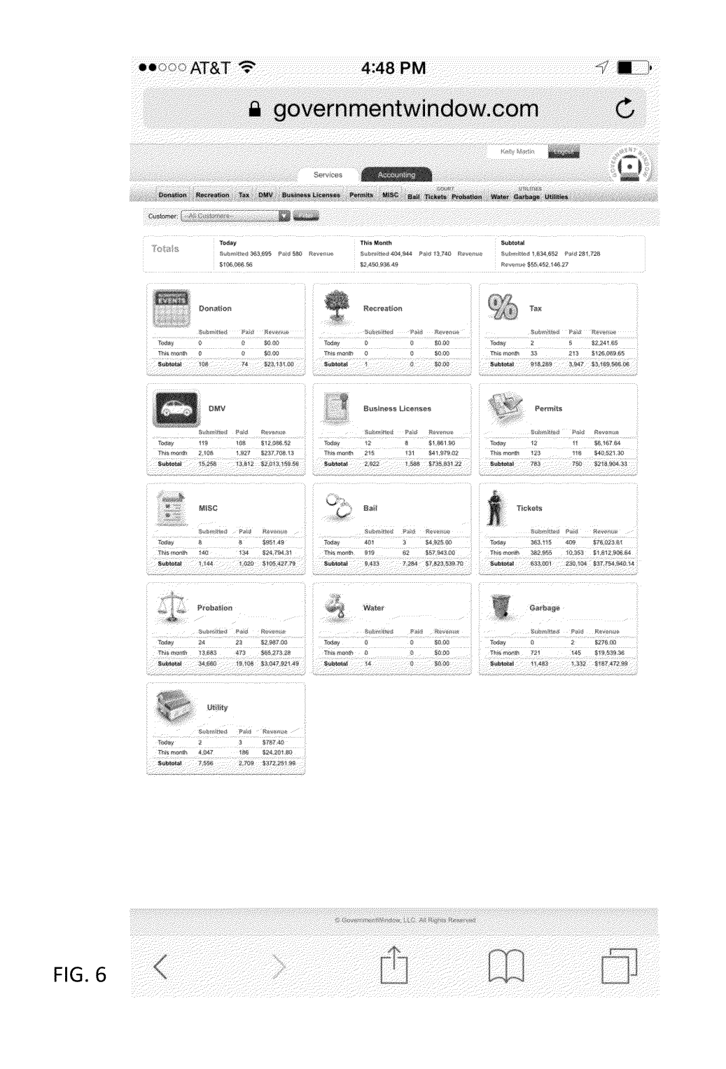

In FIG. 5, the system has an overall administrative summary screen listing various departments. Below the tabs are the totals for the day, month and year to date. The icon for each agency or department is reflected. The staff user can navigate to his or her department to see the transactions. The reporting is automatically updated.

Currently, those counties employing this system have found the accuracy is far superior to any manual system and the data generated passes audits without the need for reconciliation of errors. Those using the system are motivated to encourage all payments to be made using the system of the present invention. Collection of debts has dramatically increased yielding better, more reliable revenue flows than manual systems. Most importantly, no modifications to existing databases are required making implementation painlessly seamless.

The system of the present invention as described above is called Government Window®. Embedded within the system is the Tri-Angulation™ software for interconnecting all the various departments within a government entity like a county or city or municipality using the system and there databases of billing and accounts records. This cross agency and department interconnection permits a unique one-step payment called Government Window® Payment Compass™ to be used as described hereinafter.

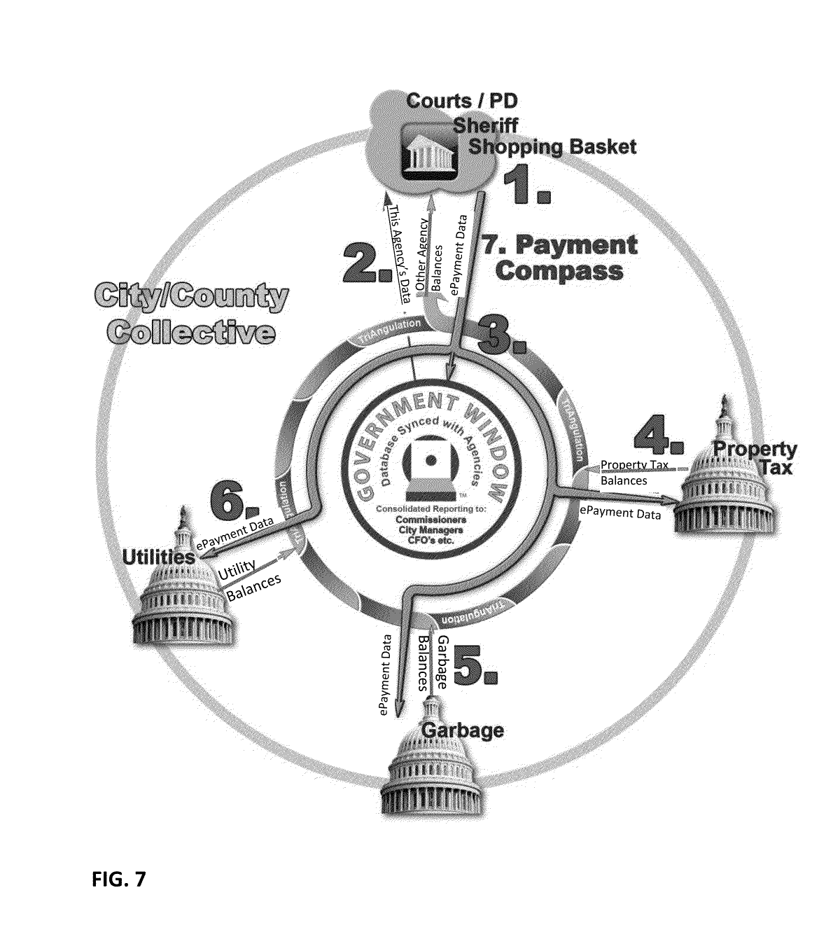

With reference to FIG. 7, a diagrammatic view of how a payment by a user of the system described above can benefit from a fully integrated and automated payment using the illustrated Government Window® Payment Compass or GW Payment Compass™ of the present invention.

The method of payment using the GW Payment Compass™ has the following steps: 1) The user initiates a Payment Application. Such an application would be an application for Tickets within the Court Applications. 2) The Application draws the data from the Database for Tickets and shows the user his balances, requesting if he wants to pay them. 3) Tri-Angulate™ searches other departments and, by way of example, finds three other agencies with outstanding balances for this user. 4: Property Tax, 5: Garbage and 6: Other Utilities. 4) Tri-Angulate™ returns the balances for Property Tax and prompts by asking the user if he wants to pay these balances as now. 5) Tri-Angulate™ returns the balances for Garbage and prompts by asking the user if he wants to pay these balances as well. 6) Tri-Angulate™ returns the balances for Utilities and prompts by asking the user if he wants to pay these balances as well. 7) All the selected payments the user chooses to pay are added to a Payment Basket within the Payment Compass™ and the user is asked to input payment method. Whatever he chooses, Payment Compass™ itemizes the bill for the user but deducts only one payment for all outstanding items with this City/County, deducts another payment for the processing fee and the proceeds to deposit the respective balances into the accounts of each of the agencies the uses chose to pay, while at the same time updating the payment records for each agency paid.

Any agency can be the initiating payment point and is not limited to Traffic Tickets/Court Citations. Any number of agencies balances can be paid depending only on whether they participate in the Tri-Angulation™ process and is not limited to the three in this example. The GW Payment Compass™ can distribute the payments in any manner the City/County designates and is not limited to exact collection amounts per agency/department. This could facilitate accommodate, for example, HB1EX surcharge/filing fee payments to Georgia Superior Court Clerks' Cooperative Authority.

This is a particularly useful and powerful tool for building permits as another example. A contractor typically has 10 or more departments to pull permits for a given site. Each department or agency has unique fees, forms and requirements. The contractor had to physically go to every agency, wait and fill out the required paperwork. The compass payment application when electronically filled out has the required information and automatically can fill out the forms using the electronic data provided by the user and create the combined invoices for all the permits virtually instantaneously along with the needed permits. What took days can be done in seconds and, more importantly, each department will have a record of the transaction and receipt of funds paid by credit card at the time the card is accepted.

Agencies naturally find the cost benefits and efficiency outstanding and the current system of the present invention is paid for by a user fee so all costs are transferred to the payor, the government agency has use of the inventive system for free and they never had to replace any existing software.

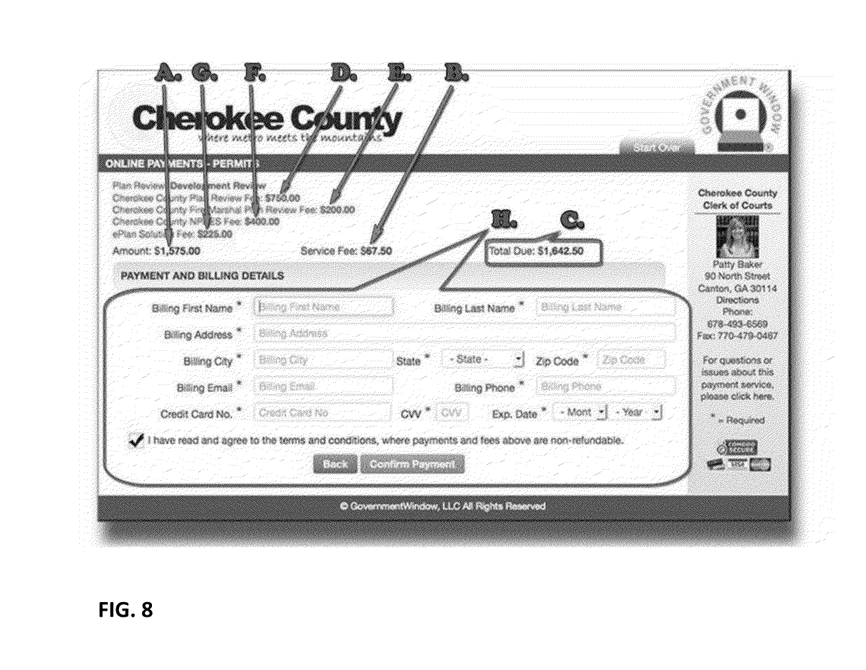

With reference to FIG. 8, alternative use of Government Window Payment Compass, by way of example. A member of the public requires permitting for a new land development which they are undertaking and must apply to the Cherokee County for the various permits defined in the local ordinances. The various permitting departments of one county are reflected in the diagram below through the amounts in G, F, D and E respectively. Each division, within Cherokee County, is autonomous from each other and has its own back-office accounting system and as such, their own bank accounts. If the public were to seek permitting without the help of Government Window permitting process, they would have to visit each of these four divisions and pay each for the services they provided individually. With the Government Window permit application, the permit seeker submits the application over the internet or through a point-of-sale kiosk or device at one of the divisional offices and pays one (1) amount as depicted in the example below under C for the following services: County plan review by the city engineering division, requires $750, as depicted by D. County fire marshal requires $200 for their review, as depicted by E. NPDES requires $400 for theirs as depicted in F. ePlan Solutions requires a fee of $225 as depicted in G. Which collectively comes to $1,575 as depicted in A, but the permit seeker only needs to authorize one singular payment of $1,642.50 through his credit card for all charges and service fees. (Including the Government Window service fee of $67.50 reflected under B). The payment screen used to make the authorization is reflected under H below and can be a typical credit card processing screen. The payment compass will collect the payment from the permit seeker upon credit card authorization through the process in C and then distribute the funds according to the allocation required by each of the county divisions as depicted in G, F, D and E below plus the Government Window service fee for these services in B.

As the name implies, the Government Window Payment Compass points the correct amount to each county division and executes a direct deposit into the account of each division in the sequence G, F, D, E and B without any additional administration by the county or additional charges by Government Window. The payment compass process is unique to Government Window and differentiates the process against all Government Window competitors. The services are voluntary insofar as the permit seeker does not have to use the Government Window service. This example allows a permit seeker to complete his entire permit applications for several divisions at a single point or location and when he completes the payment process, he will receive the necessary paperwork and receipts for each division electronically which he can either print out or save electronically. This is most efficient for the user and the permitting authorities and happens extremely quickly avoiding many hours waiting in lines at multiple locations.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. A method of using a payment compass has the following steps:
the user initiates a payment application using a payment kiosk or computer connected to an integrated system, wherein the payment application draws the data from an agency or department database showing the user his balances and requesting if he wants to pay them, and the system searches other agencies or departments and finding other agencies departments with outstanding balances for this user;
showing any other outstanding balances for each other agency or department and prompting by asking the user if he wants to pay one or more of these balances as now; and
wherein all the selected payments the user chooses to pay are added to a payment basket within the payment compass and the user is asked to input a payment method, whatever he chooses, the payment compass itemizes the bill for the user but deducts only one payment for all outstanding items with this city or county, deducts another payment for the processing fee and the proceeds to deposit the respective balances into the accounts of each of the agencies the user chose to pay, while at the same time updating the payment records for each agency paid.
